(19) United States
(12) Patent Application Publication
(10) Pub. No.: US 2026/0262698 A1
(43) Pub. Date: Sep. 10, 2026

(54) METHOD AND DEVICE FOR FABRICATING AN EDIBLE PRODUCT

(71) Applicant: Redefine Meat Ltd., Rehovot (IL)

(72) Inventors: Dekel MEIR, Gedera (IL); Sagee SCHACHTER, Tel Aviv (IL)

(21) Appl. No.: 18/881,549

(22) PCT Filed: Jul. 12, 2023
(86) PCT No.: PCT/IL2023/050726

§ 371 Date: Jan. 6, 2025

(30) Foreign Application Priority Data
Jul. 13, 2022 (IL) 294742

(51) Int. Cl. A23P 20/20; A23J 3/22; A23P 30/10

(52) U.S. Cl. CPC A23P 20/20; A23J 3/227; A23P 30/10

(57) ABSTRACT

A method of fabricating an edible product, said method comprising: (a) obtaining a plurality of first edible layers comprised of a first edible material, each of said first edible layers having one or more soles being defined by being more resilient to shearing in a direction transverse to a longitudinal axis than along the longitudinal axis, each of said first edible layers defines a layer plane including said longitudinal axis; (b) obtaining a second edible material having adhesive properties; (c) dispensing a portion of the second edible material forming a first adhesive layer on top of one of said plurality of first edible layers; (d) forming a first stack of the first edible layers with the first adhesive layer between each two first edible layers, while having the longitudinal axes of most of the first edible layers substantially parallel to each other; and (e) slicing said first stack into a plurality of mats along one or more slicing planes, each of which being parallel to the longitudinal axis and angled to the layer plane of the first edible layers being crossed thereby, whereby each mat comprises a plurality of elongated sole strands from the first edible material with the second edible material inbetween.

### TECHNOLOGICAL FIELD

The present disclosure relates to production of a method and a device for fabricating an edible product, and in particular, to fabricating an alternative meat product comprising a stack of edible layers adhered to each other.

### BACKGROUND

There is a major interest in meat analogue (also referred herein as alt-meat or alternative meat or analogues meat) due to environmental and moral factors. More and more people switch their consumption preferences without really abandoning the love to the taste of real meat. The range of desired alternative products go from minced meat and chicken nuggets, to include whole muscle cuts.

One of the elements that are difficult for reconstruction in the Alt-meat industry is the fibrillar nature of meat. In true meat, muscle fibers together with their connective tissue envelope form a highly anisotropic and strong structure that is responsible for the chewy nature of the whole muscle meat. Current methods for producing meat analogues by additive manufacturing techniques, such as WO 2020/152689, WO2021/095034 and WO2021/191906, lacks the efficiency required to make this production method suitable for operation. Accordingly, an object of the present invention is to provide a system and method of mass producing a meat analogue.

### GENERAL DESCRIPTION

The present invention relates to a system and method for production of an analogue meat product. The term meat, as will be mentioned hereinafter, relates to an animal tissue of either mammals, fish, seafood, or poultry. The term “analogue meat” as will be mentioned hereinafter, relates to a foodstuff product having similar internal arrangement of elements from a vegetarian origin that are formed, at least partially, in a similar manner to animal tissue.

An exemplary method of fabricating an edible product, comprises:
(a) obtaining a plurality of first edible layers comprised of a first edible material, each of said first edible layers having one or more soles being defined by being more resilient to shearing in a direction transverse to a longitudinal axis than along the longitudinal axis, each of said first edible layers defines a layer plane including said longitudinal axis;
(b) obtaining a second edible material having adhesive properties;
(c) dispensing a portion of the second edible material forming a first adhesive layer on top of one of said plurality of first edible layers;
(d) forming a first stack of the first edible layers with the first adhesive layer between each two first edible layers, while having the longitudinal axes of most of the first edible layers substantially parallel to each other; and
(e) slicing said first stack into a plurality of mats along one or more slicing planes, each of which being parallel to the longitudinal axis and angled to the layer plane of the first edible layers being crossed thereby, whereby each mat comprises a plurality of elongated sole strands from the first edible material with the second edible material inbetween.

It is to be understood herein that for the purposes of the present description, the longitudinal axis is to be considered as extending along the fibers of the soles.

It is to be further understood herein that for the purposes of the present description, in some examples, the one or more soles can be defined as having a tensile strength that is higher when measured in a direction along the longitudinal axis than in a direction transverse to the longitudinal axis, and in particular, in a direction perpendicular to the longitudinal axis. For the purposes of this description, it means that it is easier to tear the one or more soles apart when the sole is stretched in a direction transverse to the longitudinal axis, than in a direction along the longitudinal axis.

It is to be further understood herein that the terms “substantially” and “about” used in the present description are to be considered as indicating tolerance with respect to the corresponding feature. For instance, “substantially parallel” is to be considered as parallel with a certain tolerance of 0°-15°. With respect to pressures and/or temperatures, “substantially” and/or “about” are to be considered as including a tolerance of 1% to 30% in the respective values. With respect to being equally distanced, “substantially” and/or “about” are to be considered as including a tolerance of 0.1 mm to 5 mm.

In some examples, a gel material, which can optionally include colorant, flavoring agent, and/or fat, can be added as an additional layer in addition to or as alternative to the first adhesive layer of the second edible material. In some examples, the second edible material can include the gel material. The gel material can have adhesive properties.

In some examples, the adhesive properties of the second edible material (or the first adhesive layer) can be inherent to the respective material. In some examples, the adhesive properties of the second edible material (or the first adhesive layer) can be generated thereby after further treatment and/or time following the dispensing thereof.

Another aspect of the present disclosure relates to device for forming a substitute meat product being more resilient to shearing in a direction transverse to a longitudinal axis than along the longitudinal axis comprising:
a controller processor;
a non-transitory memory configured to store computer instructions, which are executed by the controller processor;
a first conveyor for receiving and transporting soles of a first edible material extending along a longitudinal axis of the soles, being more resilient to shearing in a direction transverse to a longitudinal axis than along the longitudinal axis;
a second conveyor for receiving and transporting stacks of soles;
a sensor configured to determine an orientation of each sole, generate sole characteristic information related thereto, and transmit the sole characteristic information to the controller processor;
a robotic arm, under control of the controller processor, configured to pick up the soles from the first conveyor and position a plurality of the soles in sole layers substantially overlapping each other, based on the sole characteristic information, positioned on the second conveyor, each of said sole layers defining a layer plane including said longitudinal axis; and
a binder applicator for applying a first adhesive layer over each sole layer;
wherein the controller processor controls the robotic arm and the binder applicator to form each stack formed with a desired number of the sole layers and the first adhesive layers.

Any one or more of the following featured designs and configurations can be applied to any of the aspects of the present disclosure, separately or in combinations thereof:

The method can further comprise:
(f) obtaining a third edible material having adhesive properties;
(g) dispensing a portion of the third edible material forming a second adhesive layer; on top of one of said two or more mats; and
(h) forming a second stack of the mats and the second adhesive layers while maintaining the mats substantially overlapping each other and maintaining an orientation of the elongated sole strands along the longitudinal axis.

The stacking of the mats provides a crisscross arrangement of the first and second adhesive layers providing a more realistic appearance with more evenly distributed adhesive layers.

In some examples, the third edible material can include a gel material, which can optionally include colorant, flavoring agent, and/or fat. In some examples, the gel material can be added as an additional layer in addition to or as alternative to the second adhesive layer of the third edible material. The gel material can have adhesive properties.

In some examples, the adhesive properties of the third edible material (or the second adhesive layer) can be inherent to the respective material. In some examples, the adhesive properties of the third edible material (or the second adhesive layer) can be generated thereby after further treatment and/or time following the dispensing thereof.

The method can further comprise:
(i) dividing the second stack into smaller segments at various acute angles to the layer plane in parallel to the longitudinal axis, to make smaller segments; and
(j) stacking the smaller segments with either the second or third edible material therebetween so as to form an alternative meat slab.

The smaller segments cut at various acute angles enable the meat slab to have a more realistic appearance with the second and third edible materials extending at various angles and lengths.

The method can further comprise:
(k) molding the alternative meat slab in a press mold.

The press mold enables the meat slab to be formed into any desired shape or size providing a more realistic appearance.

The third edible material can comprise the second edible material, thereby simplifying the process by enabling the second and third edible materials to be acquired from the same source, and to have the same appearance.

The one or more slicing planes can be perpendicular to the layer plane, providing a uniform appearance with sections of the first edible material surrounded by the second and third edible materials at right angles to each other. In some cases, the one or more slicing planes can be two or more slicing planes being about equally distanced from each other.

A fat additive can be added between at least two soles and/or mats. The fat additive provides a more realistic appearance and enhances the taste of the product.

In some examples, the fat additive can include a gel material, which can optionally include colorant and/or flavoring agent. In some examples, the gel material can be added as an additional layer in addition to or as alternative to the fat additive.

The method can further comprises marinating the soles between steps (a) and (b) to add at least one of moisture, fat, color, flavor and organic or inorganic nutrients. The marinating can provide a more realistic appearance and enhance the taste of the product. The soles can have a thickness of between 0.4 mm and 15 mm.

The method can further comprise a step of curing after each step of forming a stack. Each step of curing can comprises curing the stack for 0.5-12 hours under pressure of about 0.5 Kg/cm².

In some examples, some or all steps of curing can be preceded by subjecting the stack to repeated application of high pressure of about 8 to 10 Kg/cm² for 1 to 10 seconds in each repetition. This curing can be performed for around 2 to 6 hours, and in some examples, for around 4 hours. For instance, the stack can be intermittently subjected to high pressure of about 8 to 10 Kg/cm² for 1 to 10 seconds in each repetition, and such curing can completely cure the stack in around 4 hours. Thus, the curing time is significantly reduced. Moreover, in such examples, the intermittent subjecting to high pressure produces ‘temporary slab’, which can be more easily handled for processes including moving, cutting, etc. Further, the high pressure causes the slab to retain its shape and it can be cut (sliced) without waiting for the curing to complete.

The method can be performed in a temperature between 0° to 8° C., thereby preserving the product.

Step (h) can be performed by stacking the plurality of mats in an overlapping fashion to create an elongated stepped mat, with third edible material at least in between overlapping portions of adjacent overlapping mats;
applying a binding material on a top surface of the elongated stepped mat; and
rolling up the elongated stepped mat to create a cylindrical meat roll.

The cylindrical meat roll provides an appealing appearance that can be cut into round sections for serving.

In alternative embodiments, step (h) can be performed by arranging the plurality of mats in a contiguous fashion to create an elongated mat, and optionally, with third edible material at least on and/or between bordering portions of adjacent mats;
applying a binding material on a top surface of the elongated stepped mat; and
rolling up the elongated stepped mat to create a cylindrical meat roll.

The sole portions in the mats can extend from one end to another with the binding material therearound and therebetween, thereby providing a uniform appearance in the longitudinal direction.

The method can further comprise curing each cylindrical meat roll.

The method can further comprise covering a plurality of cylindrical meat rolls with an additional binding material and joining them while maintaining their elongated sole strands substantially parallel to each other to form a slab roll.

The first edible layers can be substantially parallel to each other. The first edible layers can be substantially between 0°-10° to each other. The first edible layers can be substantially between 0°-20° to each other. The first edible layers can be substantially between 0°-30° to each other. The first edible layers can be substantially between 0°-45° to each other. Arranging the first edible layers at different angles enables the cross section of the product to be arranged to suit the desires of the customer.

The mats can be substantially parallel to each other. The mats can be substantially 0°-10° to each other. The mats can be substantially 0°-20° to each other. The mats can be substantially 0°-30° to each other. The mats can be substantially 0°-45° to each other. Arranging the mats at different angles enables the cross section of the product to be arranged to suit the desires of the customer.

The first edible material and/or the second edible material can be straightforward edible. The first edible material and/or the second edible material are turned edible due to a preparation process.

Another aspect relates to a device for forming a substitute meat product being more resilient in a direction transverse to a longitudinal axis than along the longitudinal axis comprising:
a controller processor;
a non-transitory memory configured to store computer instructions, which are executed by the controller processor;
a first conveyor for receiving and transporting soles of a first edible material extending along a longitudinal axis of the soles, being more resilient to shearing in a direction transverse to a longitudinal axis than along the longitudinal axis;
a second conveyor for receiving and transporting stacks of soles;
a sensor configured to determine an orientation of each sole, generate sole characteristic information related thereto, and transmit the sole characteristic information to the controller processor;
a robotic arm, under control of the controller processor, configured to pick up the soles from the first conveyor and position a plurality of the soles in first edible layers substantially overlapping each other, based on the sole characteristic information, positioned on the second conveyor, each of said first edible layers defining a layer plane including said longitudinal axis; and
a binder applicator for applying a first adhesive layer over each sole layer;
wherein the controller processor controls the robotic arm and the binder applicator to form a first stack formed with a desired number of the first edible layers and the first adhesive layers.

The device can further comprise a mold mounted on the second conveyor configured to receive the first edible layers; wherein the mold can be formed with an open top and the binder applicator is moveable with respect to the second conveyer and is configured to pass back and forth over the mold for applying the first adhesive layer over each first edible layer. The mold can ensure a uniform product structure without leaking or bleeding of layers. Moving the binder applicator enables more control for applying an even layer of adhesive material.

The device can further comprise a mold mounted on the second conveyor configured to receive the first edible layers; wherein the second conveyor can be configured to reciprocate the mold underneath the binder applicator for applying the first adhesive layer over each sole layer. The mold can ensure a uniform product structure without leaking or bleeding of layers. Moving the second conveyor enables the binder applicator to be held steady ensuring an even layer of adhesive material.

The device can further comprise a cutting unit configured to supply a required number of half or partial soles, from which the robotic arm can be configured to pick up and place in the mold, as required to complete each sole layer.

The device can further comprise a slab maker configured for cutting the first stack into mats and stacking the mats into a second stack, the slab maker can comprise:
a slicer configured to receive the first stacks from the second conveyor and to slice the first stack into mats;
operators configured to feed the first stacks to the meat slicer and/or direct the mats out from the meat slicer;
a third conveyor configured to receive and transfer the mats from the slicer;
a first applicator disposed above the third conveyor and configured to apply a second adhesive layer to each of the mats running thereunder; and
a mat stacker configured to receive and stack the mats from the third conveyor, the mat stacker can be configured to continually weigh the second stack of mats and release the second stack when the second stack reaches a target weight.

The stacking of the mats provides a crisscross arrangement of the first and second adhesive layers providing a more realistic appearance with more evenly distributed adhesive layers.

The device can further comprise a second applicator provided over top the third conveyor configure to dispense a fat additive. The fat additive can provide a more realistic appearance and enhances the taste of the product. In some examples, the fat additive can include a gel material, which can optionally include colorant and/or flavoring agent. In some examples, the gel material can be added as an additional layer in addition to or as alternative to the fat additive.

The device can further comprise a garbage removal tray configured to collects at least a first slice of the first stack and throw it away or repurpose in some other product.

The device can further comprise:
a press mold configured for molding the second stack into a desired shape; and
a buffer conveyor extending from the mat stacker to transfer the stacked piles to the press molds.

It is to be understood herein that the press mold can be configured to process the stack according to any of the curing processes described herein.

The device can further comprise a conveyor cleaning box configured for cleaning off excess waste from the third conveyor. In other embodiments, cleaning elements and/or systems can be adjoined with other parts of the device as well, including other conveyors, dispensers, the cutting elements, and the like.

Another aspect relates to a substitute meat product produced by any one of the aforementioned methods or devices.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A illustrates a plurality of soles of a meat substitute;

FIG. 1B illustrates a stack of soles alternating with binder layers;

FIG. 2A illustrates a plurality of sole layers stacked in a mold;

FIG. 2B illustrates a plurality of sole layers stacked in a mold;

FIG. 3 illustrates an automated sole stacking system;

FIG. 4 illustrates a stack of sole layers cut into mats;

FIG. 5 illustrates a stacked pile of mats alternating with binder layers;

FIGS. 6A and 6B illustrate a stacked pile of mats trimmed for packaging;

FIG. 7 illustrates a slab maker;

FIGS. 8A to 8D illustrate a process for forming an alternative meat slab;

FIGS. 9A to 9C illustrate a process of forming an elongated stepped mat;

FIGS. 10A to 10C illustrate a process of forming a cylindrical meat roll; and

FIGS. 11A and 11B illustrate a process of forming a roll slab.

### DETAILED DESCRIPTION OF EMBODIMENTS

The present invention relates to a method and system for fabricating an alternative meat edible product which resembles animal tissues. In some cases, the alternative meat edible product can be purely vegan, while in other cases, the alternative meat edible product can be vegetarian. In yet other cases the meat edible product can include non vegan additives. The way in which the edible product resembles animal tissues is by having an internal orientation of a plurality of distinct elements attached together, where each of the plurality of distinct elements is configured with the same directionality as the others and held together with the other distinct elements, in a similar manner to the way muscle fibers are arranged and held together in animal tissue.

In general, the edible product is formed by stacking first layers of edible material and joining them together to form an array of stacked layers attached to each other. The stack can undergo cutting to form a plurality of second layers, each having high-protein strands joined together to each other. The created second layers mimic the structure of muscle fibers along a 2-dimensional array, with all the strands of the first layers having substantially the same orientation, like muscle tissue in meat, and being connected to each other, for example by adhesive material, like the connective tissue in meat.

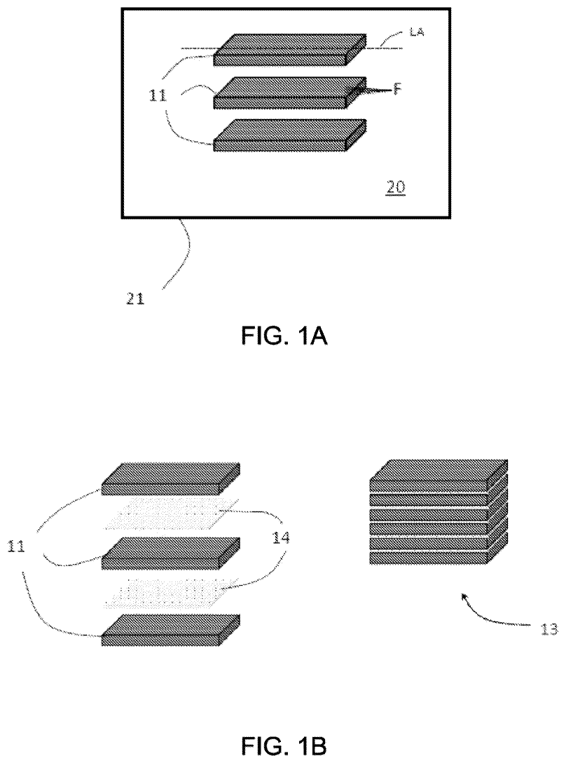

With reference to FIGS. 1-5, in an initial step a plurality of first edible “sole” layers 12 (interchangeably referred to herein as first edible layers 12 or sole layers 12) comprised of a first edible material, hereinafter referred to as “soles”, are obtained, each having one or more soles 11. Each sole 11 is defined by exhibiting an anisotropic physical property when the physical parameter is measured from three different essentially orthogonal directions thereof. In some cases, the physical parameter can be an anisotropic textural property, such as hardness, gumminess, chewiness, young modulus and cohesiveness. In specific cases, the physical parameter is being more resilient to shearing in a direction transverse to a longitudinal axis LA than along the longitudinal axis LA. In an example of the presently disclosed subject matter, each sole 11 can comprise a plurality of edible protein fibers (F) extending mostly along an axis being parallel to the longitudinal axis LA. Each of the first edible “sole” layers 12 defines a layer plane including the longitudinal axis LA. In some examples, the first edible material forming the first edible layers is a textured vegetable protein.

A second edible material having adhesive properties is also obtained for forming a first adhesive or binder layer 14. The second edible material can be configured to enable sufficient adhering and/or binding of the first edible “sole” layers 12 to one another, either mechanically or chemically, in a varying temperatures and conditions to prevent separation of the portions of the first edible “sole” layers 12 from each other once cut and held together thereby. In some examples, the second edible material can include a gel material, which can optionally include colorant, flavoring agent, and/or fat, and/or can have adhesive properties, and can be added as an additional layer in addition to or as an alternative layer to the first adhesive layer of the second edible material. In some examples, the first adhesive layer can be constituted by more than one layer, whereas one or more of these layers can include the above-mentioned gel material. In some examples, the adhesive properties of the second edible material (or the first adhesive layer 14) can be inherent to the respective material. In some examples, the adhesive properties of the second edible material (or the first adhesive layer 14) can be generated thereby after further treatment and/or time following the dispensing thereof.

As shown in FIG. 1A, in some embodiments, the individual pieces of the first edible material, may be soaked in a marinade 20, e.g., in a suitable container, such as a vat 21, to add at least one of moisture, fat, color and flavor. The soles 11 may have a thickness of between 0.4 mm and 15 mm, preferably between 2 mm and 8 mm, and more preferably 2 mm and 5 mm. When the raw sole 11 is too thick, an optional step may be added of cutting the raw sole 11 to create soles having the desired thickness. Each sole 11 is defined as being more resilient to shearing in a direction transverse to a longitudinal axis than along the longitudinal axis. In some embodiments, each sole 11 is comprised of elongated sole strands extending along or parallel to the longitudinal axis.

With reference to FIG. 1B, a plurality of the soles 11 are stacked in a plurality of sole layers 12 in an oriented stack 13 (interchangeably referred to herein as a first stack) with the first adhesive layer 14 between each of the plurality of sole layers 12 (interchangeably referred to herein as first edible layers). Each adhesive layer 14, e.g., gluten or gluten based substance, is added between each sole layer 12 during preparation of the stack 13. Typically, 4-12% by weight of the stack 13 is made up of the adhesive layers 14. The adhesive layers 14 may be added by spreading, jetting, spraying, dripping or putting full glue panels of typically 0.01 to 1 mm thickness.

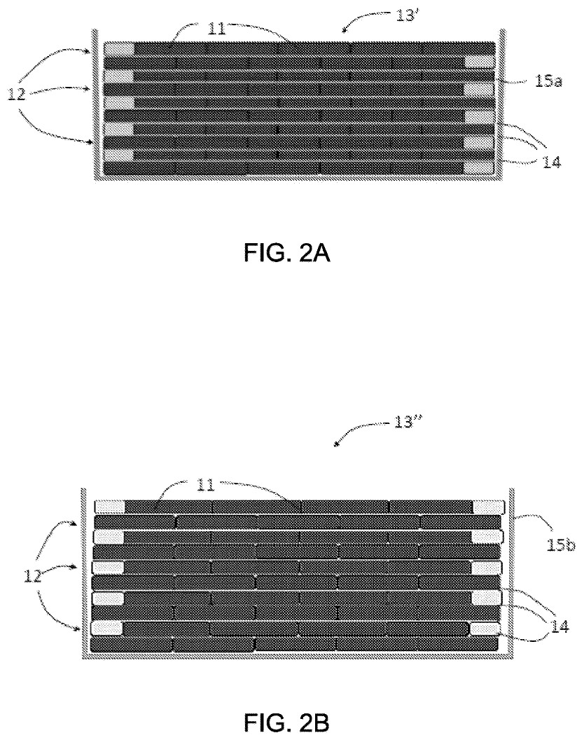

The stack 13 may be built as a single or a plurality of contiguous columns of soles 11 or, as shown in FIGS. 2A and 2B, as a wider stack 13′ (FIG. 2A) or 13″ (FIG. 2B) with offsetting sole layers 12 inside a dedicated mold 15 (which can be sorted, for example as molds 15a or 15b shown in FIGS. 2A and 2B, respectively), which may be referred to as enlarged cartridge. Each first edible “sole” layer 12 in the wide stack 13′ or 13″ comprises a plurality of soles, e.g., 4-8, aligned side by side, e.g., with the flat side facing down and the tangent edge is the longer one. It is to be understood herein that the terms “wide” and “wider” are used herein to indicate the stacks 13′ and 13″ are wider than the stack 13 formed by the plurality of contiguous columns of soles 11. In some embodiments, each sole layer 12 is comprised of elongated sole strands from each sole 11 extending along or parallel to the longitudinal axes and each other. If the number of soles 11 needed to fill a sole layer 12 inside the mold 15b is a whole number, then one sole layer 12 may be made of the whole soles 11 and the following sole layer 12 may have a half sole 11 on each end (or any other ratio as long as the aggregate length of both cut soles is of one sole). If the number of soles 11 is not a whole number inside mold 15a, then each sole layer 12 may be laid out with the whole soles 11 next to each other and then a cut sole 11 at one of the ends to complete the sole layer 12. The cut sole 11 may alternate ends with adjacent superposed sole layers 12. Each of said first edible layers defines a layer plane including the longitudinal axis of each sole 11.

In some embodiments, the first edible layers, i.e., sole layers 12, are substantially parallel to each other. Alternatively, the first edible layers, i.e., sole layers 12, are substantially between 0°-10° to each other, substantially between 0°-20° to each other, substantially between 0°-30° to each other or substantially between 0°-45° to each other. Arranging the first edible layers at different angles enables the cross section of the product to be arranged to suit the desires of the customer.

In some embodiments, each adhesive layer 14 can consist of only gluten or gluten based adhesive. In other embodiments, each adhesive layer can comprise a different adhesive material and can be mixed with other materials to create a stronger adhesion or enhance flavor and/or nutritional value, e.g., pea protein, egg protein, starch, and vitamin C. The amount of adhesive added, is typically calculated to be 5-15%, and in some examples, to 7-12% of the weight of the previous sole layer; however, with the added chemicals the amount of adhesive might go down to 0-6% of the weight of the previous sole layer.

In some embodiments, the first edible material and/or the second edible material are straightforward edible; however, in alternative embodiments, the first edible material and/or the second edible material are turned edible due to a preparation process.

In an optional step, the stacks 13 may be put aside for the ‘curing’ of the adhesive in the adhesive layers 14. For pure gluten, curing time may be 0.5-12 hours at a temperature range of about −10° to 16° Celsius. The inventors have found that curing at a temperature range of about −7° to 4° Celsius may reduce over-freezing on one side of the slab and minimize contamination on the other side. This rate may change given the size, weight and composition of the stacks, as well as other variables, in order to optimize curing of the stacks 13. The stacks 13 may also be left to cure under moderate pressure, e.g., typically 0.5 Kg/cm², for better adhesive results of the adhesive layers 14.

In some examples, curing can be preceded by subjecting the stack to repeated application of high pressure of about 8 to 10 Kg/cm² for 1 to 10 seconds in each repetition. This curing can be performed for around 2 to 6 hours, and in some examples, for around 4 hours. For instance, the stack can be intermittently subjected to high pressure of about 8 to 10 Kg/cm² for 1 to 10 seconds in each repetition, and such curing can completely cure the stack in around 4 hours. Thus, the curing time is significantly reduced. Moreover, in such examples, the intermittent subjecting to high pressure produces ‘temporary slab’ which can be more easily handled for processes including moving, cutting, etc. Further, the high pressure causes the slab to retain its shape and it can be cut (sliced) without waiting for the curing to complete.

The compressed pile may then be cooled until the core of the stacks 13 reach a temperature of between 0° to 8° C., preferably about 4° C. Time and pressure are required for the adhesive to be effective.

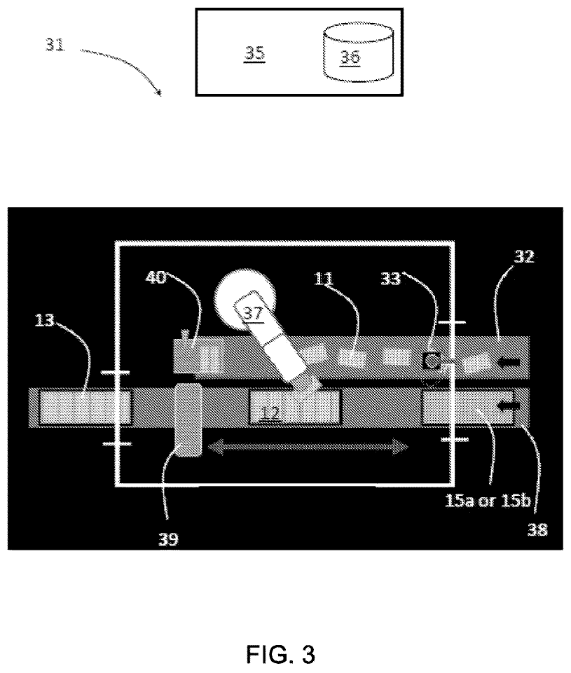

With reference to FIG. 3, an automated sole stacking system 31 constitutes a device for forming a substitute meat product, for example as described herein above, and includes a first conveyor 32 for receiving and transporting individual soles 11. The first conveyor 32 transports each sole 11 under a visual sensor 33, which identifies, measures and determines an orientation of each sole 11, possibly with additional characteristic information for each sole 11, and transmits the sole characteristic information to a controller processor 35. The controller processor 35 executes computer instructions saved on non-transitory memory 36 configured for controlling the sole stacking system 31. At least one robotic arm 37, under control of the controller processor 35, picks up the soles 11, e.g., either one or more at a time, and positions each of the picked up soles 11 in one of the dedicated surface and/or mold 15 that is positioned on a second conveyor 38, so as to form a sole layer 12 (interchangeably referred to herein as a first edible layer 12). After each sole layer 12 is completed, the controller processor 35 then moves the mold 15 activates a binder applicator 39 for applying an adhesive layer 14 (interchangeably referred to herein as first adhesive layer 14) over each sole layer 12. The binder applicator 39 may be mounted on a linear rail so that the binder applicator 39 may be passed back and forth over the mold 15 for applying the adhesive layer 14, or the second conveyor 38 may transport and locate the mold 15 underneath the binder applicator 39 for applying the adhesive layer 14. After each sole layer 12 and adhesive layer 14 are formed, the controller processor 35 may cause the repeating of these steps for subsequent sole layers 12 and adhesive layers 14 until the stack 13 is formed with the desired dimensions (e.g., height) and/or number of sole layers 12. A full mold 15 may then be transported away via the second conveyor 38. For molds 15a or 15b requiring half or partial soles 11, a cutting unit 40 is provided to supply the required number of half or partial soles 11, from which the robotic arm 37 picks up and places in the mold 15, as required to complete a sole layer 12.

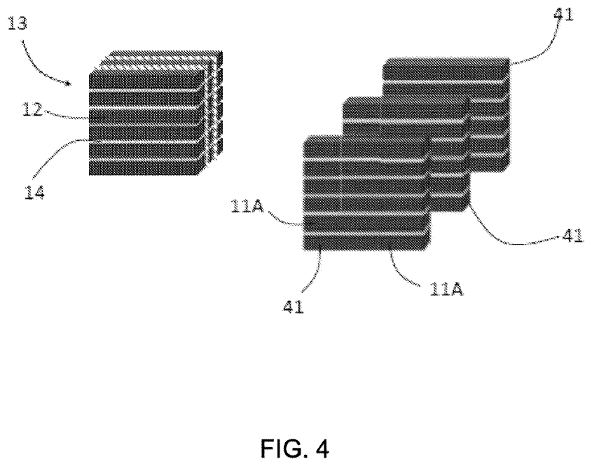

With reference to FIG. 4, each stack 13 of sole layers 12 is rotated by 90°and placed in a slicing machine. Each stack 13 is sliced at an angle, e.g., perpendicular, to the plane of the sole layers 12 and adhesive layers 14, to create a plurality fibrous mats 41, while still maintaining the alternating sole layer 12 and adhesive layer 14 pattern. Each mat 41 may be 80 mm to 150 mm long, preferably 110 mm to 130 mm, and 50 mm to 160 mm wide, preferably 55 mm-100 mm. The thickness of each mat 41 may be between 0.5 mm-5 mm.

In another embodiment of the presently disclosed subject matter, each of the second layers can be joined to another second layer to form a second stack of three dimensional array of sole strands connected by adhesive materials, thereby further mimicking the structure of real animal tissue. In some cases, the second layers of the second stack can have different arrangement of sole strands and adhesive material from each other to provide further diversity to the formed meat substitute.

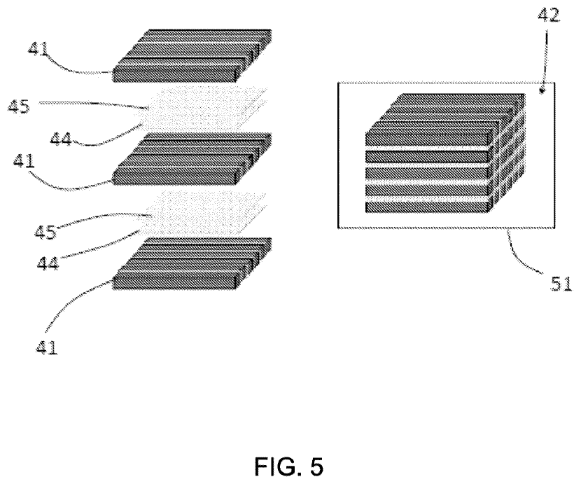

An example to the forming of the second stack is shown in FIG. 5, in which a first exemplary finishing process comprises restacking the mats 41 one on top of each other in parallel, with all strands substantially in the same direction forming a stacked pile 42 (interchangeably referred to herein as a second stack 42). A second plurality of adhesive layers 44, comprised of a third edible material, e.g., adhesive, such as gluten, are positioned in between each adjacent superposed mats 41. In some embodiments, a fat additive 45 is added between mats 41 layers during the stacking process. The fat additive 45 may be incorporated into the second adhesive layers 44, deposited as an independent layer parallel to the adhesive layer 44 or incorporated in the stacked pile 42 in some other suitable way. The first adhesive layers 14 may extend perpendicular to the second plurality of adhesive layers 44 or at any suitable or desired angle. A similar stacking process and machinery may be used for stacking mats 41 as in stacking sole layers 12, as described with reference to FIG. 3. Typical quantities of fat additives and adhesive include 2% to 15%, preferably 8% to 12%, of the weight of each mat 41.

In some examples, the third edible material can include a gel material, which can optionally include colorant, flavoring agent, and/or fat, and/or can have adhesive properties, and can be added as an additional layer in addition to or as an alternative layer to the second adhesive layer of the third edible material. In some examples, the second adhesive layer can be constituted by more than one layers, whereas one or more of these layers can include the above-mentioned gel material.

In some examples, the adhesive properties of the third edible material (or the second adhesive layer 44) can be inherent to the respective material. In some examples, the adhesive properties of the third edible material (or the second adhesive layer 44) can be generated thereby after further treatment and/or time following the dispensing thereof. In some examples, the fat additive can include a gel material, which can optionally include colorant and/or flavoring agent, and can be added as an additional layer in addition to or as an alternative layer to the fat additive layer. In some examples, the fat additive layer can be constituted by more than one layers, whereas one or more of these layers can include the above-mentioned gel material.

The stacked pile 42 may be cured as aforementioned. Alternatively, the stacked pile 42 can undergo two-step curing, whereas the first step include partial curing as aforementioned and a second step, in which the stacked pile is inserted into a press mold 51 that presses on the stacked pile 42 to mold it into a certain shape, and then the press mold 51 is inserted into an additional curing in a cooled environment. In some cases, the additional curing can comprise cooling said mold for 2-8 hours in 4° Celsius. The press mold 51 forms the stacked pile 42 into any desired shape, e.g., aesthetically pleasing and/or resembling a desired meat product.

In some examples, the stack can be cured by subjecting to repeated application of high pressure of about 8 to 10 Kg/cm² for 1 to 10 seconds in each repetition. This curing can be performed for around 2 to 6 hours, and in some examples, for around 4 hours. For instance, the stack can be subjected intermittently to high pressure of about 8 to 10 Kg/cm² for 1 to 10 seconds in each repetition, and such curing can completely cure the stack in around 4 hours. Thus, the curing time is significantly reduced. Moreover, in such examples, the intermittent subjecting to high pressure produces ‘temporary slab’ which can be more easily handled for processes including moving, cutting, etc. Further, the high pressure causes the slab to retain its shape and it can be cut (sliced) without waiting for the curing to complete.

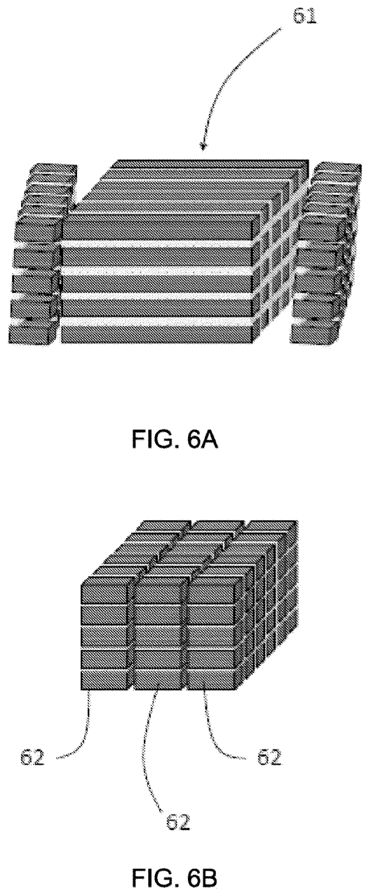

In some embodiments, the low temperature is needed for food preservation not necessarily for faster curing. With reference to FIG. 6A, the cured stacked pile 42 of mats 41 may be trimmed to create clean edges. The result is an alternative meat slab 61. The meat slab 61 (or slab or stacked pile) may be further divided into homogeneous or geometrically distinct segments 62 for packaging, transportation and sale (FIG. 6B).

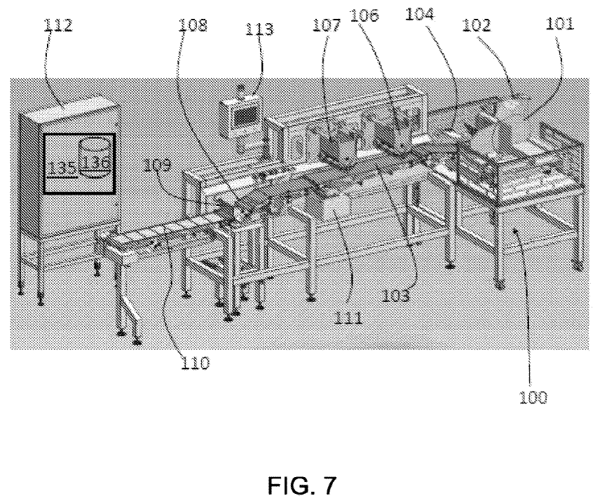

With reference to FIG. 7, a slab maker 100 is configured for cutting the stacks 13 into mats 41 and stacking the mats 41 into the stacked pile 61. Initially a slicer 101 receives the stacks 13, e.g., from the automated sole stacking system 31, and slices the stacks 13 into mats 41. In some embodiments, the slicer 101 slices the stacks 13 along one or more slicing planes, each of which being angled in a same angle to the layer plane, whereby each mat 41 comprises a plurality of elongated sole strands (11A) from the first edible layers with the second edible material in between. The slab maker 100 may be automated under control of a controller processor 135 (may be the same or a different controller processor than controller processor 35), which is configured to execute computer instructions stored in non-transitory memory 136 (may be the same or a different non-transitory memory than memory 36).

Operators 102, e.g., pneumatic fingers, are provided to enable the controller processor 135 to feed the stacks 13 to the meat slicer 101 and/or direct the mats 41 from the meat slicer 101 to a conveyor 103, which may be constituted by one or a plurality of conveyors operating together to form a single production line. A garbage removal tray 104 may be provided to collects the first few slices of each stack 13 and throw them away or repurpose in some other product.

A first applicator 106, e.g., duster, is disposed above the conveyor 103 configured to apply the second plurality of adhesive layers 44, e.g., an adhesive powder such as gluten, to the mats 41 running thereunder. In some embodiments, the first applicator 106 is installed on a moving arm or support to enable the first applicator 106 to travel to the mats 41, as required. A second applicator 107 may be provided over top of a different section of the conveyor 103 than the first applicator 106 to dispense the fat additive 45. The second applicator 107 may be a duster or similar device, to dispense “sensory fat”, or an applicator (such as a P.C.P pump) configured to dispense “visual fat”. In some cases, the first and second applicators 106 and 107 can be positioned interchangeably to each other with respect to the conveyor 103.

A mat stacker 108 is configured to receive and stack the mats 41 from the conveyor 103. The mat stacker 108 may also continually weigh each pile of mats 41 and when the stacked pile 61 reaches the target weight or dimensions, the mat stacker ceases to stack the mats 41 and send the pile of mats 41 forward on conveyor 103 or different conveyor. In some embodiments, the mats 41 are substantially parallel to each other. Alternatively, the mats 41 are substantially between 0°-10° to each other, substantially between 0°-20° to each other, substantially between 0°-30° to each other or substantially between 0°-45° to each other. Arranging the mats 41 at different angles enables the cross section of the stacked pile 61 product to be arranged to suit the desires of the customer. In the present example of FIG. 7, the conveyor 103 comprise a stopper 109, which prevents the stack the mats 41 to leave the mat stacker 108. However, the stack the mats 41 may be prevented from leaving the mat stacker 108 by other means such as by one of the plurality of conveyers constituting the conveyer 103.

A buffer conveyor 110 extend from the mat stacker 108, i.e., the end of the conveyor 103, enables workers to collect and transfer the stacked piles 61 to the press molds 51, if required. A conveyor cleaning box 111, e.g., comprised of a scraper and/or a spinning brush may be provided at a convenient location along the conveyor 103 for cleaning off excess waste from the conveyor 103. In some embodiments, a control box 112 is provided for housing the controller processor 135, the memory 136 and any other electronics, air pressure systems and drivers etc., as required. A display screen 113 may be provided for displaying the status of the slab maker 100, and the various components thereof as well as other parameters required for the control and operation of the system, e.g., speed of conveyor 103, weight of current stacked pile 61, amount of binder in first applicator 106.

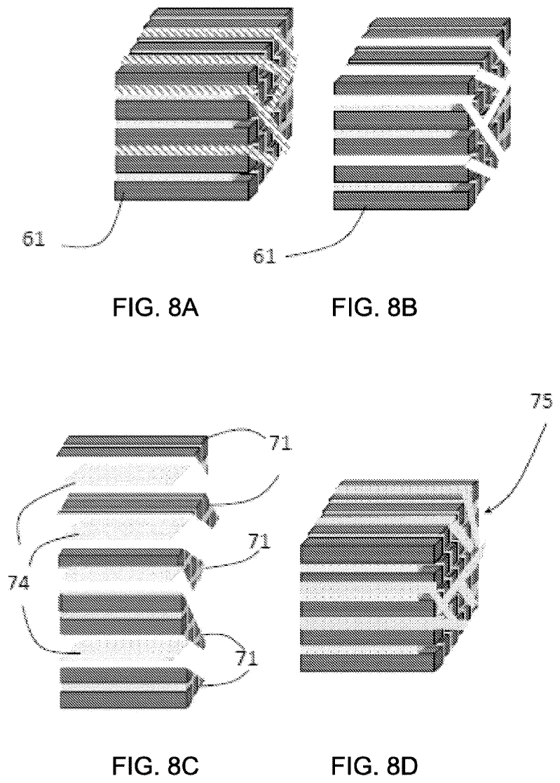

With reference to FIGS. 8A to 8D, in some embodiments, the cured meat slab 61 is further divided into smaller segments, either by cutting or tearing the cured meat slab 61 at various acute angles to the plane of the second adhesive layers 44 in parallel to a longitudinal axis of the fiber making up the soles 11, to make smaller segments 71, as in FIGS. 8A and 8B. The smaller segments 71 may be separated and stacked with a plurality of third adhesive layers 74 (FIG. 8C) forming an alternative meat slab 75. The alternative meat slab 75, may be put in a press mold, according to the final resulting structure desired. FIG. 8D shows a scheme arbitrarily chosen. The mold 15 is set aside for curing of the second adhesive layer 44, under pressure, e.g., typically 0.5 Kg/cm², and at a temperature of 0° to 8° C., preferably about 4° C. The result is the alternative meat slab 75, with subdivisions imitating smaller and less symmetric “muscle” groups. The alternative meat slab 75 may be packaged, transported and sold, as is, or subjected to further processing, e.g., cut into segments 62, as above.

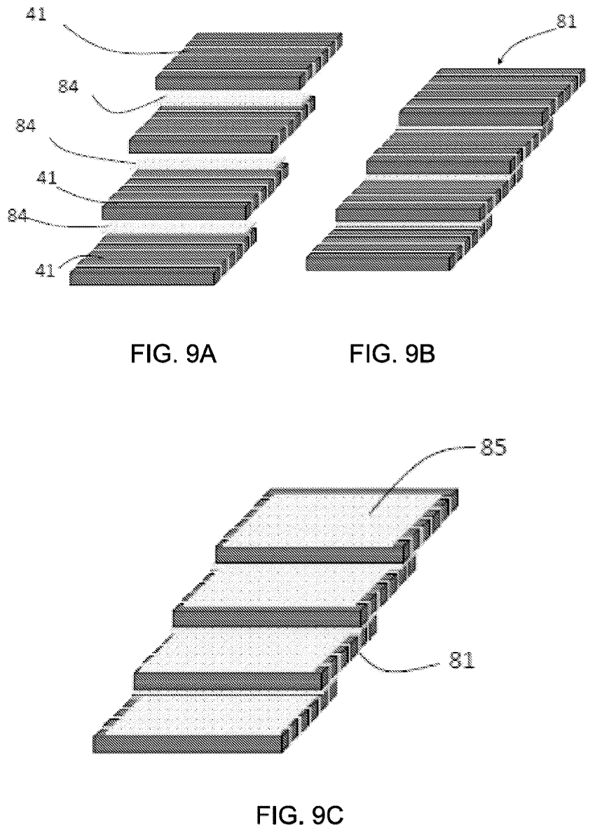

With reference to FIGS. 9A to 9C, a second exemplary finishing process utilizing the mats 41, from FIG. 4, and fabricated as hereinbefore described with reference to FIGS. 1 to 3, is illustrated. A binding material 84, e.g., an edible adhesive, is applied to a portion, e.g., about ⅓, proximate one end of each mat 41, except the top mat 41, creating a rectangle of adhesive, which may be parallel to the longitudinal axis of the fibers from the soles 11. The mats 41 are stacked in an overlapping fashion, like shingles, to create essentially an elongated stepped mat 81, with the binding material 84 in between the overlapping portions of the adjacent superposed mat 41.

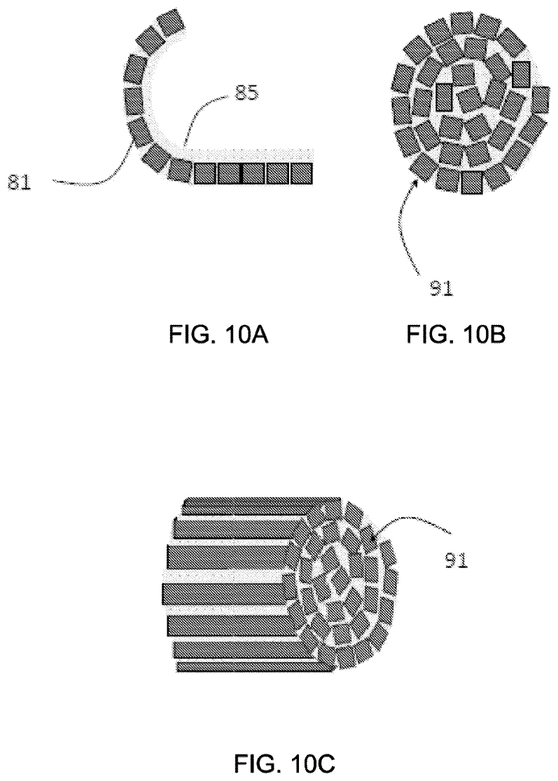

Then a coating 85 of a binding material, e.g., an edible adhesive such as gluten, is applied to the top of the elongated stepped mat 81, to cover the remaining portion, e.g., about ⅔, of the mats 41 that were left exposed. The fat additive 45 may then be added to the long mat 81, if desired. The elongated stepped mat 81 may then be rolled up tightly (FIG. 10A) to create a cylindrical meat roll 91 with fibers extending from one end to the other with the binding material 84 and 85 therearound and therebetween. as shown in the FIGS. 10B and 10C. The meat roll 91, may be cured in a press mold, under pressure, e.g., typically 0.5 Kg/cm², at a temperature of 0° to 8° C., preferably about 4° C.

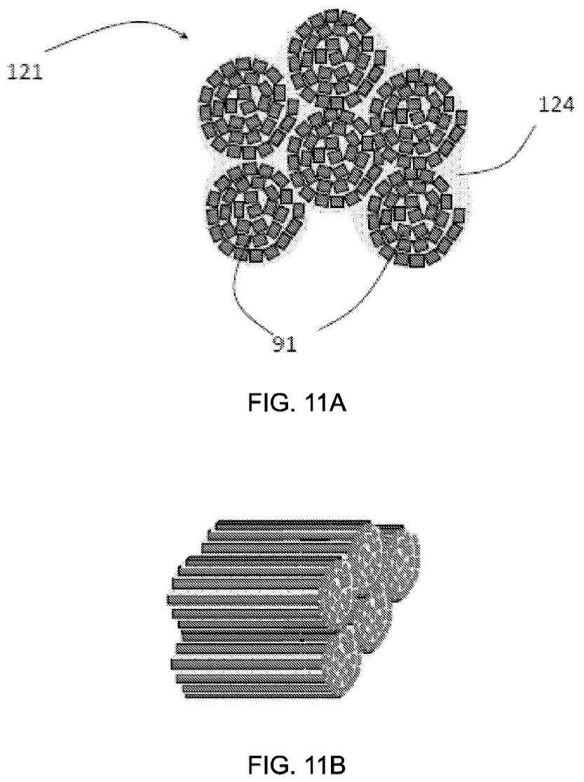

With reference to FIGS. 11A and 11B, several meat rolls 91 may be covered with an additional binding material 124, e.g., an adhesive powder such as gluten, to form a slab roll 121. The slab roll 121 may be put in a press mold for suitable final shaping. The slab roll 121 may be cured in press mold, e.g., under pressure typically 0.5 Kg/cm², at a temperature of about 0° to 8° C., preferably about 4°. The resulting slab roll 121 is an alternative meat with subdivision to smaller “muscle” groups.

There may be various ways to create a roll. Roll around “classic slab”; roll around “Clustered slab”; Roll around “Roll grouping slab”; and any other combination of the above.

1. A method of fabricating an edible product, said method comprising:
(a) obtaining a plurality of first edible layers comprised of a first edible material, each of said first edible layers having one or more soles being defined by being more resilient to shearing in a direction transverse to a longitudinal axis than along the longitudinal axis, each of said first edible layers defines a layer plane including said longitudinal axis;
(b) obtaining a second edible material having adhesive properties;
(c) dispensing a portion of the second edible material forming a first adhesive layer on top of one of said plurality of first edible layers;
(d) forming a first stack of the first edible layers with the first adhesive layer between each two first edible layers, while having the longitudinal axes of most of the first edible layers substantially parallel to each other; and
(e) slicing said first stack into a plurality of mats along one or more slicing planes, each of which being parallel to the longitudinal axis and angled to the layer plane of the first edible layers being crossed thereby, whereby each mat comprises a plurality of elongated sole strands from the first edible material with the second edible material inbetween.

2. The method according to claim 1, further comprising:
(f) obtaining a third edible material having adhesive properties;
(g) dispensing a portion of the third edible material forming a second adhesive layer; on top of one of said plurality of mats; and
(h) forming a second stack of the mats and the second adhesive layers while maintaining the mats substantially overlapping each other and maintaining an orientation of the elongated sole strands along the longitudinal axis.

3. The method according to claim 2, further comprising:
(i) dividing the second stack into smaller segments at various acute angles to the layer plane in parallel to the longitudinal axis, to make smaller segments;
(j) stacking the smaller segments with either the second or third edible material therebetween so as to form an alternative meat slab; and
(k) molding the alternative mean slab in a mold.

4. The method according to claim 2, further comprising:
(i) molding the second stack into a desired shape in a press-mold.

5. The method according to claim 2, wherein the third edible material comprises the second edible material.

6. The method according to claim 2, wherein step (h) is performed by stacking the plurality of mats in an overlapping fashion to create an elongated stepped mat, with the third edible material at least in between overlapping portions of adjacent overlapping mats;
applying a binding material on a top surface of the elongated stepped mat; and
rolling up the elongated stepped mat to create a cylindrical meat roll.

7. The method according to claim 2, wherein step (h) is performed by arranging the plurality of mats in a contiguous fashion to create an elongated mat, and optionally, with the third edible material at least on and/or between bordering portions of adjacent mats;
applying a binding material on a top surface of the elongated mat; and
rolling up the elongated mat to create a cylindrical meat roll.

8. The method according to claim 6, wherein sole strands in the mats extend from one end to another with the binding material therearound and therebetween.

9. The method according to claim 7, further comprising curing each cylindrical meat roll.

10. The method according to claim 7, further comprising covering a plurality of cylindrical meat rolls with an additional binding material and joining them while maintaining their elongated sole strands about parallel to each other to form a slab roll.

11. The method according to claim 2, wherein the adhesive properties of the second adhesive layer is either inherent to the respective material or is generated thereby after further treatment and/or time following the dispensing thereof.

12. The method according to claim 2, wherein the mats are one of:
(a) substantially parallel to each other;
(b) at an angle of between 1° and 45° to each other.

13. (canceled)

14. (canceled)

15. (canceled)

16. (canceled)

17. The method according to claim 1, wherein the one or more slicing planes are two or more slicing planes being substantially equally distanced from each another.

18. The method according to claim 1, further comprising providing a fat additive between at least two soles and/or mats.

19. The method according to claim 1, further comprising marinating the soles between steps (a) and (b) to add at least one of moisture, fat, color, flavor and organic or inorganic nutrients.

20. (canceled)

21. The method according to claim 1, further comprising a step of curing after each step of forming a stack.

22. (canceled)

23. The method according to claim 1, wherein the method is performed in a temperature between 0° to 8° C.

24. The method according to claim 1, wherein the adhesive properties of the first adhesive layer is either inherent to the material or is generated thereby after further treatment and/or time following the dispensing thereof.

25. The method according to claim 1, wherein the first edible layers are one of.
(a) substantially parallel to each other, or
(b) at an angle of between 1° and 45° to each other.

26. (canceled)

27. (canceled)

28. (canceled)

29. (canceled)

30. (canceled)

31. (canceled)

32. A device for forming a substitute meat product being more resilient to shearing in a direction transverse to a longitudinal axis than along the longitudinal axis along a longitudinal axis than along an axis angled thereto, the device comprising:
a controller processor;
a non-transitory memory configured to store computer instructions, which are executed by the controller processor;
a first conveyor for receiving and transporting soles of a first edible material extending along a longitudinal axis of the soles, being more resilient to shearing in a direction transverse to a longitudinal axis than along the longitudinal axis;
a second conveyor for receiving and transporting stacks of soles;
a sensor configured to determine an orientation of each sole, generate sole characteristic information related thereto, and transmit the sole characteristic information to the controller processor;
a robotic arm, under control of the controller processor, configured to pick up the soles from the first conveyor and position a plurality of the soles in first edible layers substantially overlapping each other, based on the sole characteristic information, positioned on the second conveyor, each of said first edible layers defining a layer plane including said longitudinal axis; and
a binder applicator for applying a first adhesive layer over each first edible layer;
wherein the controller processor controls the robotic arm and the binder applicator to form a first stack formed with a desired number of the first edible layers and the first adhesive layers.

33. The device according to claim 32, further comprising a mold mounted on the second conveyor configured to receive the first edible layers; wherein the mold is formed with an open top and the binder applicator is moveable with respect to the second conveyer and is configured to pass back and forth over the mold for applying a binder layer over each first edible layer.

34. The device according to claim 32, further comprising a mold mounted on the second conveyor configured to receive the sole layers; wherein the second conveyor is configured to reciprocate the mold underneath the binder applicator for applying the first adhesive layer over each first edible layer.

35. The device according to claim 32, further comprising a cutting unit configured to supply a required number of half or partial soles, from which the robotic arm is configured to pick up and place in the mold, as required to complete each sole layer.

36. The device according to claim 32, further comprising a slab maker configured for cutting the first stack into mats and stacking the mats into a second stack, the slab maker comprising:
a slicer configured to receive the stacks from the second conveyor and to slice the stacks into mats;
operators configured to feed the first stack to the meat slicer and/or direct the mats out from the meat slicer;
a third conveyor configured to receive and transfer the mats from the slicer;
a first applicator disposed above the third conveyor and configured to apply a second adhesive layer to each of the mats running thereunder; and
a mat stacker configured to receive and stack the mats from the third conveyor, the mat stacker is configured to continually weigh the second stack of mats and release the second stack when the second stack reaches a target weight.

37. The device according to claim 36, further comprising a second applicator provided over top the third conveyor configure to dispense a fat additive.

38. (canceled)

39. The device according to claim 36, further comprising:
a press mold configured for molding the second stack into a desired shape; and
a buffer conveyor extending from the mat stacker to transfer the second stack to the press mold.

40. (canceled)

41. A substitute meat product produced by the method of claim 1.
